(19) United States
(12) Patent Application Publication
(10) Pub. No.: US 2015/0161152 A1
(43) Pub. Date: Jun. 11, 2015

(54) CONTENT AGGREGATOR FOR SYNCHRONOUS CONTENT DISTRIBUTION

(71) Applicant: AT&T Intellectual Property I, L.P., Atlanta, GA (US)

(72) Inventors: Richard H. Voyentzie, Smyrna, GA (US); Edward Kim, Carrollton, TX (US); Mark Wilson, Houston, TX (US)

(73) Assignee: AT&T Intellectual Property I, L.P., Atlanta, GA (US)

(21) Appl. No.: 14/101,485

(22) Filed: Dec. 10, 2013

(51) Int. Cl. G06F 17/30

(52) U.S. Cl. CPC G06F 17/3089

(57) ABSTRACT

Managing content for distribution includes receiving a uniform resource locator of a content item via a web portal. The web portal controls access to a template through which the uniform resource locator is received. Managing the content also includes storing the uniform resource locator as a hyperlink in a database, transmitting a uniform resource locator for a website of the web portal to an end user device, and providing the end user device with access to the hyperlink via the uniform resource locator of the website.

### BACKGROUND

The present disclosure relates generally to web applications and, more particularly, to a content aggregator for synchronous content distribution.

As more computer devices are designed for mobility (e.g., tablet PCs, smart phones, etc.), there has been a surge in the amount of information exchange, in both the business realm as well as the consumer realm, with regard to these devices. For example, many business enterprises now provide employees with portable devices to maintain contact and conduct business while away from the office (e.g., while travelling or when working in the field).

In many instances, a business will provide one or more business applications that can be installed on the devices in furtherance of the business' goals. Also, the business may have various web resources that are utilized by business employees through their portable devices. However, when an update is made to server based content or a web resource, the update needs to be propagated across all employee devices based on user subscriptions, which can be a tedious and time consuming task.

### BRIEF SUMMARY

Exemplary embodiments include methods, systems, and computer program products for managing content for distribution. A method includes receiving a uniform resource locator of a content item via a web portal. The web portal controls access to a template through which the uniform resource locator is received. The method also includes storing the uniform resource locator as a hyperlink in a database, transmitting a uniform resource locator for a website of the web portal to an end user device, and providing the end user device with access to the hyperlink via the uniform resource locator of the website.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 depicts a system upon which content management processes may be implemented in accordance with an exemplary embodiment;

FIG. 2 depicts a flow diagram illustrating a process for implementing content management in accordance with an exemplary embodiment;

FIG. 3 depicts a user interface screen of an administrator web page in accordance with an exemplary embodiment; and

FIG. 4 depicts a user interface screen as seen by an end user of the content management processes in accordance with an exemplary embodiment.

### DETAILED DESCRIPTION OF EXEMPLARY EMBODIMENTS

Content management of applications and network resources is provided. The content management provides a way to aggregate various content items, such as applications, widgets, web pages, documents, and multimedia files, associate the content with defined user groups, and to provide access to this content by the designated user groups through corresponding hyperlinks. Updates to the content may be made, and the updated content is distributed across a network to respective end user devices. In one embodiment, administrators associated with web content may utilize a portal to select, edit, and publish the content, and may provide end users with access to the content based on subscriptions.

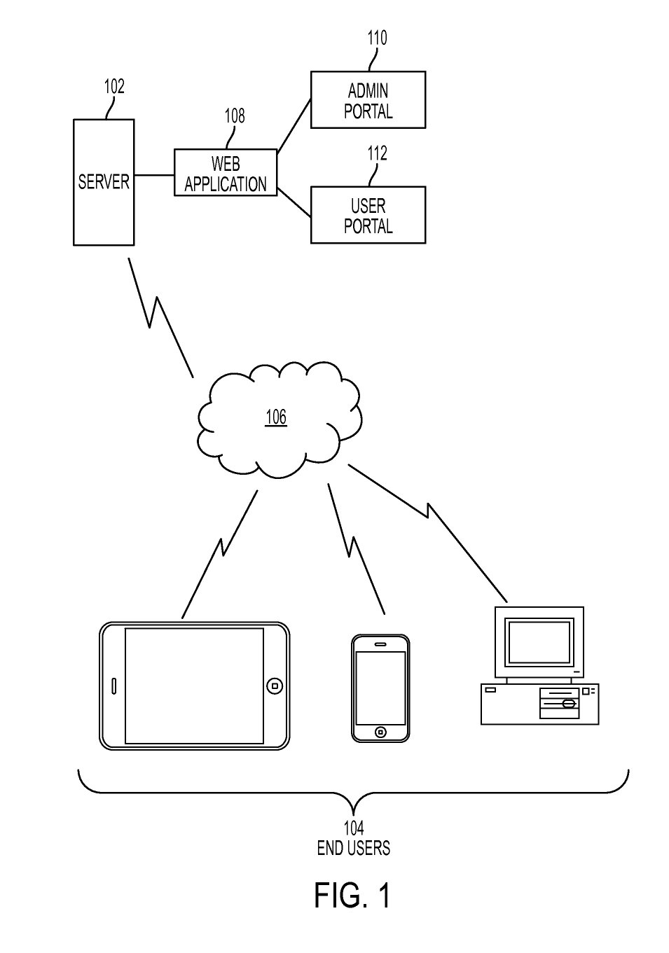

Turning now to FIG. 1, a system 100 upon which content management processes may be implemented will now be described in an exemplary embodiment. The system 100 includes a host system computer 102 and end user devices 104 communicatively coupled to one or more networks 106.

The host system computer 102 may be a web server operated by an enterprise hosting content management services. In one embodiment, the host system computer 102 may be operated by a business enterprise that aggregates content for use by its employees. The host system computer 102 may be implemented as a high-speed computer processing device, e.g., a mainframe computer. In an embodiment, the host system computer 102 includes memory for storing content items for access by individuals, as will be described further herein.

The end user devices 104 may be computer processing devices operated, e.g., by employees of the business enterprise. The end user devices 104 may include wireless mobile devices, such as a tablet PC or smartphone, as well as wired devices, such as a general-purpose computer or laptop. The end user devices 104 may be equipped with communications components (e.g., cellular, wireless LAN, NFC, Bluetooth, USB) for communicating over wireless or wired communications mediums.

Networks 106 may include area networks, private networks, and the Internet. The networks may include wireless networks, such as cellular, satellite and terrestrial networks. Communications may be conducted between the host system computer 102 and the end user devices 104 via wireless transmissions, such as ultra mobile broadband (UMB), long term evolution (LTE), and IEEE 802.11, as well as via wired links, such as twisted pair link, a T1/E1 phone line, an AC line, an optical fiber line, and coaxial cable, to name a few.

The host system computer 102 executes a web application 108 for implementing the content management processes described herein. The web application 108 includes an administrator portal 110 component and an end user portal 112 component. Each of the portals 110 and 112 relate to web portals.

The administrator portal 110 enables an administrator or other authorized representative to manage content for distribution to the end user devices 104. The administrator portal 110 may be accessed by the administrator using specified security credentials. From this portal 110, the administrator may add, edit, and delete content items, and define categories of content items, as well as create and modify user groups. In addition, as indicated above, at least some of the content items may be in the form of widgets (e.g., downloadable software applications implemented using web technologies such as JavaScript, HTML, and CSS). The administrator may select from a number of widgets for distribution to end users through the administrator portal 110. These features are described further herein.

The end user portal 112 enables end users (e.g., through the end user devices 104) to access the content items provided by the administrator, e.g., under terms of a subscription.

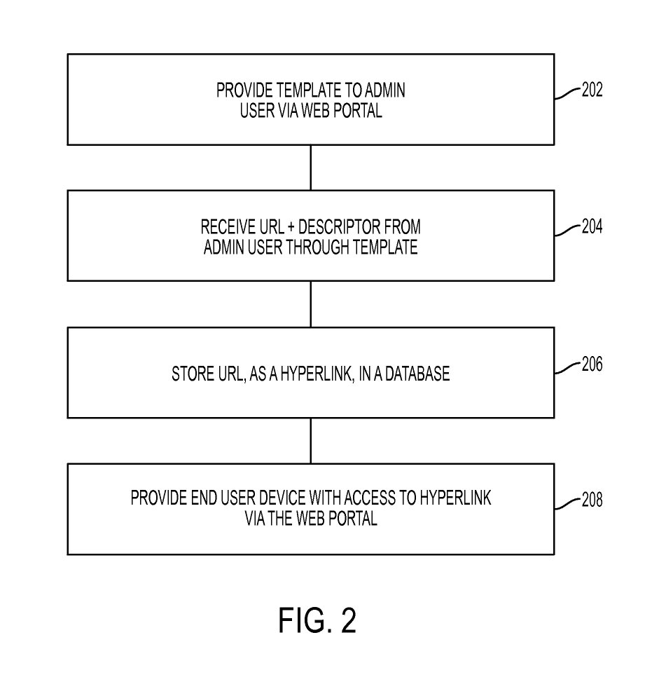

Turning now to FIG. 2, a flow diagram of a process for implementing the content management services will now be described. The process of FIG. 2 assumes that an administrator has logged in to the web application 108 at the host system computer 102 and seeks to create a new content item for a group.

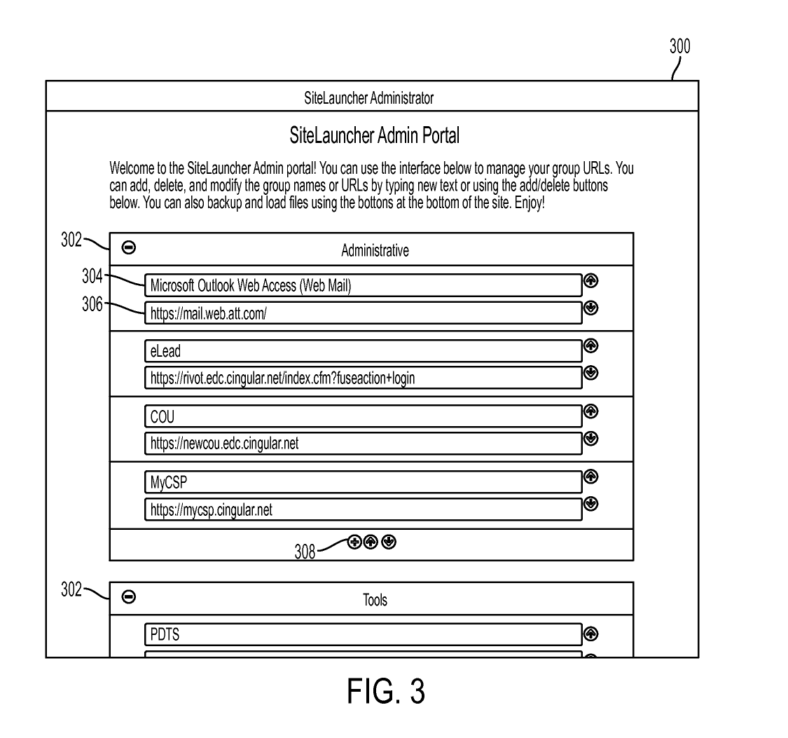

At step 202, the administrator portal 110 provides a template via the portal 110. A sample template is shown within a user interface screen 300, as depicted in FIG. 3. At step 204, the administrator portal 110 receives a uniform resource locator (URL) of a content item via the template. As shown in FIG. 3 by way of illustration, categories 302 (“Administrative” and “Tools”) have been defined for various content items.

A new content item for a category 302 (e.g., Administrative) can be added by selecting an icon 308 and entering descriptor for the content item in a field 304, as well as a URL of the content item in a field 306 of the template. The new content item may be assigned to a category based on the subject matter of the content item.

When the changes have been completed by the administrator, the administrator portal 110 saves the URL and descriptor to a database at step 206. The URL may be stored as a hyperlink in the database. The URL and descriptor are associated with a group of end users through a website URL and naming convention associated with the host system computer 102. For example, the website URL may include a domain name followed by a forward slash and a group name. In one embodiment, the administrator may define subscriptions for enabling (and restricting) access to the content items. For example, certain identified content items may be designated as private, while others may be designated as public. Content items designated as private are accessible only to end users selected by the administrator, while other content items may be freely accessible to end users. Content items having either classification of content items may be provided on a subscription basis to the end users.

The web application 108 transmits the URL for the website to the respective end user devices associated with the group. Alternatively, the URL for the website may be stored on the end user devices and accessed through selection of a corresponding icon on the devices.

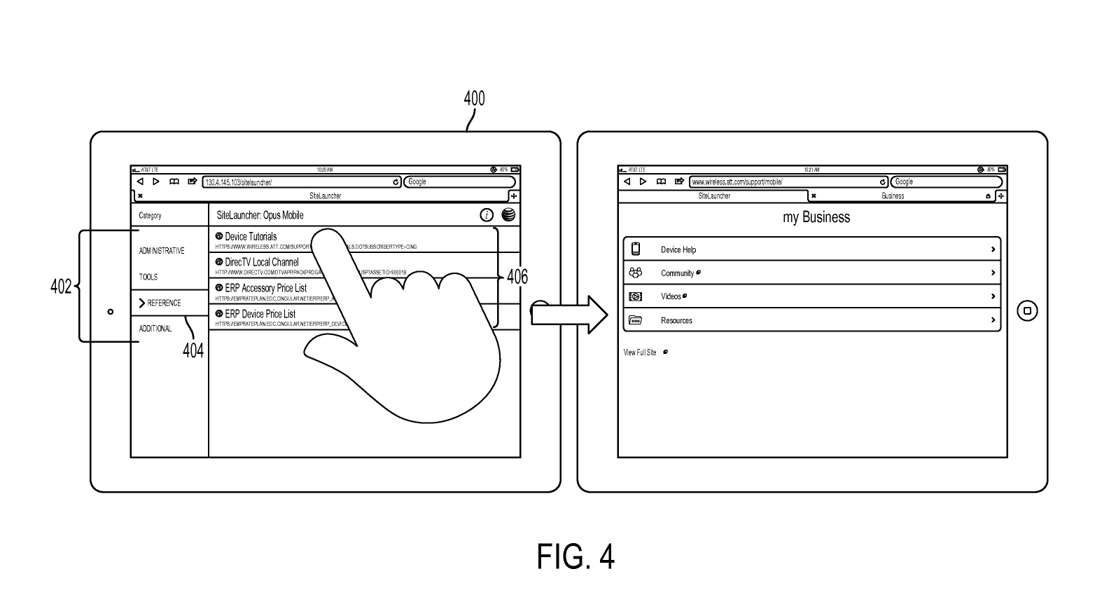

At step 208, the web application 108 provides the end user devices 104 with access to the end user portal 112 and corresponding content items via the URL of the website. As shown in FIG. 4, a user device 400 (104) has selected the URL of the website and a computer screen window is generated. The selection of the URL causes the end user portal 112 to allow for the download of each of the content items associated with the categories assigned to the respective user.

In FIG. 4, for example, the end user has selected a category 404 “Reference” from a list of categories 402 associated with the end user's group. By selecting the category 404, a list of corresponding content items for the category is then displayed on the device.

In an embodiment, the web application 108 is configured to enable access to content items across a variety of different devices and platforms. For example, the content items may be rendered in a standard-based markup language format such that the content item can be accessed using any type of operating system.

As indicated above, the content management processes provide distributed, synchronized updates for content items through the website of the portal. When the administrator completes the update via the template, the update is stored in the database for a particular group of end users through the URL of the website, and access is provided to the update when the URL of the website is accessed via the end user devices.

As described above, the exemplary embodiments can be in the form of processor-implemented processes and devices for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes a device for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc., do not denote any order or importance, but rather the terms first, second, etc., are used to distinguish one element from another. Furthermore, the use of the terms a, an, etc., do not denote a limitation of quantity, but rather denote the presence of at least one of the referenced item.

What is claimed is:

1. A method for managing content for distribution, the method comprising:
receiving a uniform resource locator of a content item via a web portal, the web portal controlling access to a template through which the uniform resource locator is received;
storing the uniform resource locator, as a hyperlink, in a database;
transmitting a uniform resource locator for a website of the web portal to an end user device; and
providing the end user device with access to the hyperlink via the uniform resource locator of the website.

2. The method of claim 1, further comprising:
providing, via the template, an option to add, delete, and modify uniform resource locators and widgets.

3. The method of claim 1, further comprising:
classifying hyperlinks into categories based on subject matter.

4. The method of claim 3, further comprising:
upon receiving a request from the end user to download a web page associated with a hyperlink assigned to one of the categories, transmitting each of the hyperlinks associated with the one of the categories to an end user device of the end user.

5. The method of claim 1, wherein the content item is a web page.

6. The method of claim 1, wherein the content item is a multimedia file.

7. The method of claim 1, further comprising:
providing a distributed, synchronized update for the content item through the website of the web portal, the synchronized update provided by storing the update in the database, associating the update with a group of end user devices through the uniform resource locator of the website, and providing access to the update when the end user devices access the uniform resource locator of the website.

8. The method of claim 1, wherein the providing the end user device with access to the hyperlink includes providing the content item in a standard-based markup language format such that the content item is accessible via the hyperlink across multiple operating system platforms.

9. A system for managing content for distribution, comprising:
a computer processing device; and
memory comprising computer-executable instructions, that when executed by the computer processing device, cause the computer processing device to perform operations, the operation comprising:
receiving a uniform resource locator of a content item via a web portal, the web portal controlling access to a template through which the uniform resource locator is received;
storing the uniform resource locator, as a hyperlink, in a database;
transmitting a uniform resource locator for a website of the web portal to an end user device; and
providing the end user device with access to the hyperlink via the uniform resource locator of the website.

10. The system of claim 9, the operations further comprising:
providing, via the template, an option to add, delete, and modify uniform resource locators and widgets.

11. The system of claim 9, the operations further comprising:
classifying hyperlinks into categories based on subject matter.

12. The system of claim 11, the operations further comprising:
upon receiving a request from the end user to download a web page associated with a hyperlink assigned to one of the categories, transmitting each of the hyperlinks associated with the one of the categories to an end user device of the end user.

13. The system of claim 9, wherein the content item is a web page.

14. The system of claim 9, wherein the content item is a multimedia file.

15. The system of claim 9, the operations further comprising:
providing a distributed, synchronized update for the content item through the website of the web portal, the synchronized update provided by storing the update in the database, associating the update with a group of end user devices through the uniform resource locator of the website, and providing access to the update when the end user devices access the uniform resource locator of the website.

16. A computer program product, tangibly embodied on a computer readable medium, for managing content for distribution, the computer program product including instructions that, when executed by a processor, cause the processor to perform operations comprising:
receiving a uniform resource locator of a content item via a web portal, the web portal controlling access to a template through which the uniform resource locator is received;
storing the uniform resource locator, as a hyperlink, in a database;
transmitting a uniform resource locator for a website of the web portal to an end user device; and
providing the end user device with access to the hyperlink via the uniform resource locator of the website.

17. The computer program product of claim 16, the operations further comprising:
providing, via the template, an option to add, delete, and modify uniform resource locators and widgets.

18. The computer program product of claim 16, the operations further comprising:
classifying hyperlinks into categories based on subject matter.

19. The computer program product of claim 18, the operations further comprising:
upon receiving a request from the end user to download a web page associated with a hyperlink assigned to one of the categories, transmitting each of the hyperlinks associated with the one of the categories to an end user device of the end user.

20. The computer program product of claim 1, the operations further comprising:
providing a distributed, synchronized update for the content item through the website of the web portal, the synchronized update provided by storing the update in the database, associating the update with a group of end user devices through the uniform resource locator of the website, and providing access to the update when the end user devices access the uniform resource locator of the website.
